(19) United States
(12) Patent Application Publication
(10) Pub. No.: US 2024/0023209 A1
(43) Pub. Date: Jan. 18, 2024

(54) SUB-SEA FACILITY AND METHOD FOR HEATING A MULTI-PHASE EFFLUENT FLOWING INSIDE A SUBSEA CASING

(71) Applicant: SAIPEM S.A., Montigny le Bretonneux (FR)

(72) Inventors: Raymond HALLOT, Voisins le Bretonneux (FR); Thomas VALDENAIRE, Courbevoie (FR)

(21) Appl. No.: 18/257,448

(22) PCT Filed: Oct. 27, 2021
(86) PCT No.: PCT/FR2021/051885

§ 371 Date: Jun. 14, 2023

(30) Foreign Application Priority Data
Dec. 18, 2020 (FR) FR2013626

(51) Int. Cl. H05B 6/10; E21B 43/01

(52) U.S. Cl. CPC H05B 6/108; E21B 43/01; H05B 2214/03

(57) ABSTRACT

A subsea installation for heating a multiphase effluent circulating inside a subsea shell, includes at least one pipeline section disposed along a vertical direction and has an inner tube, an outer tube disposed around the inner tube while being coaxial therewith, a thermal insulation layer, and a system for heating by induction the outer tube. The outer tube has at a lower end an intake aperture to allow circulation of the multiphase effluent from bottom to top in an annular space delimited between the outer tube and the inner tube. The inner tube opening is at an upper end inside the outer tube and emerges at a lower end towards a discharge outlet for the multiphase effluent to allow counter-current circulation of the multiphase effluent from top to bottom inside the inner tube.

### Technical field

The present invention relates to the general field of heating the fluid transport metal pipelines, and particularly the subsea pipelines resting on the seabed and ensuring a connection between subsea hydrocarbon, in particular oil and gas, production wells and a surface installation for example a floating production, storage and offloading unit.

### PRIOR ART

In the same offshore hydrocarbon production field, it is common to operate several wells that can be separated from each other by several kilometers, even tens of kilometers. The multiphase effluents (liquid/gas/solid mixture) from these different wells must be collected by subsea pipelines laid on the seabed and transferred by bottom/surface connection pipelines to a surface installation, for example a ship or an onshore collection point, which will collect them for storage (and possibly for processing).

Furthermore, due to their extraction at an increased depth in the subsoil, the multiphase effluents from the subsea hydrocarbon production wells exit at a relatively high temperature at seabed level (typically of the order of 70° C.). Sea water being generally cold, especially at increased depths where it is typically of 4° C., if no provision is made to retain the heat of the effluents leaving the production wells, these will gradually cool down while traveling the kilometers of subsea pipelines. However, these two-phase effluents contain various chemical compounds for which a cooling causes troublesome phenomena to appear for the maintenance of good circulation conditions.

Thus, the gas molecules, in particular methane, combine with the water molecules to form, at low temperature, hydrate crystals. These can stick to the walls, agglomerate there and lead to the formation of plugs capable of blocking the subsea pipeline. Similarly, the oil-solubility of the high molecular weight compounds, such as paraffins or asphaltenes, decreases when the temperature drops, which gives rise to solid deposits which are also capable of blocking the subsea pipeline.

A known solution for avoiding the formation of plugs in the subsea pipelines consists in heating the subsea pipelines over their entire length using one or more electric cables which are wound around the pipelines to heat them by the Joule effect. This solution, which is called “trace heating”, makes it possible to maintain the two-phase effluents transported in the subsea pipelines at a temperature above a critical threshold throughout their entire path from the production well to the surface installation.

This solution presents obvious problems related to the installation of such electric heating cables over the entire length of the subsea pipelines, with the significant costs that this represents in terms of installation and maintenance. In addition, the trace heating is based on the continuity of the installation all along the subsea pipelines. However, if this continuity were to be broken for one reason or another at one location in the pipelines, the entire installation would be out of service. This constraint therefore makes it necessary to consider this type of heating only for the phases called transported effluent preservation phases, and not for the operational phases of operation.

There is known from the publication WO 2016/066968 a local heating station which can be placed in several locations along the subsea pipelines in order to ensure a sufficient level of temperature of the transported effluents over a very great length of pipelines. In practice, each heating station can comprise a number of horizontal conduit windings which is a multiple of the number of phases of the electric supply current, the conduit windings each being a conduit section around which a solenoid is wound, the solenoids being electrically connected so as to obtain a three-phase mounting. This type of architecture thus offers great ease of installation and great flexibility of use.

The design of the local heating station makes it possible to inject very high levels of thermal power while minimizing the length of pipeline to be heated and respecting a maximum pipeline temperature (typically of the order of 150° C.). However, although effective, the heating station solution presented in the publication WO 2016/066968 requires heating very great pipeline lengths, which considerably increases the weight and dimensions of the heating station.

There is also known the patent application FR 19 14434 filed on Dec. 13, 2019, by the Applicant which discloses a subsea heating installation comprising heated pipeline sections which are slightly tilted relative to the horizontal (with an angle comprised between 2 and 10°) in order to avoid a stratified flow and promote a pattern of distributed flow of the effluent. This type of flow indeed makes it possible to significantly improve the heat exchange coefficient and therefore to promote the transfer of very high thermal powers.

The solution described in this patent application consisting of slightly tilting the pipeline sections has the advantage of avoiding promoting a stratified flow which is inhomogeneous and detrimental to the heat exchange coefficient. On the other hand, the installation of this solution is relatively bulky with large site coverage due to the essentially horizontal position of the pipeline sections.

### DISCLOSURE OF THE INVENTION

The main object of the present invention is therefore to propose a subsea heating installation that does not have the aforementioned drawbacks.

In accordance with the invention, this aim is achieved by means of a subsea installation for heating a multiphase effluent circulating inside a subsea shell, comprising at least one pipeline section disposed along a substantially vertical direction, the pipeline section comprising an inner tube, an outer tube disposed around the inner tube while being coaxial therewith, a thermal insulation layer disposed around the outer tube, and a system for heating by induction the outer tube disposed around the thermal insulation layer, the outer tube comprising at a lower end an intake aperture in order to allow circulation of the multiphase effluent from bottom to top in an annular space delimited between the outer tube and the inner tube, and the inner tube opening at an upper end inside the outer tube and emerging at a lower end towards a discharge outlet for the multiphase effluent in order to allow counter-current circulation of the multiphase effluent from top to bottom inside the inner tube.

The heating installation according to the invention is remarkable in particular in that it provides circulation of the effluent from bottom to top in the annular space between the tubes, then circulation from top to bottom inside the inner tube with a reversal of the effluent at the upper end of the pipeline section. This configuration has the advantage that if a gas pocket is formed and stagnates at the high point of the device, it is not subjected to the induction heating. If this gas pocket is larger, it will be driven towards the inner tube to overflow into the upper portion thereof and will thus be protected from the induction heating by the liquid flow present therearound in the annular space delimited between the outer tube and the inner tube. In this way, it is possible to prevent a gas pocket from being subjected to the induction heating which can lead to a destructive overheating of the thermal insulation layer.

The heating installation according to the invention is also remarkable in that the verticality of the flows of the multiphase effluent inside the pipeline section makes it possible to promote a particularly advantageous distributed flow pattern in order to significantly increase the coefficient of heat exchange between the pipeline section and the multiphase effluent (in particular relative to a stratified flow pattern). The transfer of very high thermal powers can be promoted. In this way, the length of the pipeline section can be reduced, which greatly limits the bulk of the installation.

Advantageously, the inner tube of the pipeline section opens at an upper end inside the outer tube at an end segment thereof which is devoid of induction heating.

The end segment of the outer tube of the pipeline section advantageously has at its upper end a curved shape outwards so as to limit the pressure drops of the flow of the multiphase effluent during its passage from the annular space towards the inner tube.

In this case, the end segment of the outer tube of the pipeline section can contain a conical part which is curved inwards so as to improve the guiding of the effluent from the annular space towards the inner tube.

The passage section of the annular space can be substantially equal to the passage section of the inner tube. Thus, the upward (in the annular space) and downward (in the inner tube) flow speeds of the multiphase effluent are substantially equal to each other.

Preferably, the pipeline section comprises a plurality of centralizers which are positioned in the annular space between the outer tube and the inner tube. These centralizers ensure centering and maintenance of the inner tube inside the outer tube.

The system for heating by induction the pipeline section can comprise at least one induction coil wound around the thermal insulation layer and supplied with alternating electric current so as to generate an induced current in the outer tube to heat it.

In this case, the pipeline section further preferably comprises a flexible shell disposed around the induction coil of the heating system in order to form a hermetic enclosure, said enclosure being filled with a liquid at equal pressure with the external environment.

The inner tube of the pipeline section is advantageously made of a corrosion-resistant alloy. Indeed, its thickness and its weight are relatively low compared to the outer tube because the very low-pressure differential it undergoes is disproportionate to the one that the outer tube undergoes.

The installation can comprise a plurality of pipeline sections which are supplied with multiphase effluent via a common distributor into which the intake aperture of the outer tube of each pipeline section emerges.

Particularly, the installation can comprise at least two bundles of pipeline sections, each bundle comprising a plurality of pipeline sections, the pipeline sections of one of the bundles being supplied with multiphase effluent via a common distributor and supplying in series or in cascade multiphase effluent to the pipeline sections of another bundle whose discharge outlets emerge towards a common manifold.

In this case, the installation can comprise two bundles of pipeline sections each comprising nine pipeline sections. Alternatively, the installation can comprise three bundles of pipeline sections each comprising six pipeline sections.

The pipeline sections of all the bundles are advantageously arranged inside the same parallelepiped volume in several distinct groups of pipeline sections corresponding to the different bundles or in an interlocked disposition of the pipeline sections of the different bundles.

The invention also relates to a method for the subsea heating of a multiphase effluent circulating inside a subsea shell, comprising the circulation, along a vertical direction from bottom to top, of the multiphase effluent inside an annular space delimited between coaxial outer and inner tubes of a vertical pipeline section, followed by counter-current circulation, along a vertical direction from top to bottom, of the multiphase effluent inside the inner tube of the pipeline section, with the application of an induction heating of the outer tube of the pipeline section.

The method according to the invention thus provides for heat exchanges between the upward and downward streams which are similar to those of a counter-current heat exchanger: the downward stream gives up heat to the upward stream which is heated to a large extent by the outer tube subject to the induction heating, but also to a lesser extent by the inner surface of the inner tube, which is heated by the upward stream.

### BRIEF DESCRIPTION OF THE DRAWINGS

FIG. 1 is a schematic view of a subsea installation for heating a multiphase effluent according to the invention.

FIG. 2 is a magnification of FIG. 1 showing the lower portion of a pipeline section of the installation of FIG. 1.

FIG. 3 is a magnification of FIG. 1 showing the upper portion of a pipeline section of the installation of FIG. 1.

FIG. 4 is a sectional view along IV-IV of FIG. 3.

FIG. 5 shows an example of arrangements of the pipeline sections of the installation according to the invention.

FIG. 6 shows an example of the electrical connections of the system for heating the installation of FIG. 5.

### DESCRIPTION OF THE EMBODIMENTS

The invention applies to any network of subsea pipelines ensuring a connection between at least a subsea hydrocarbon production well and a surface installation.

Such a subsea pipeline network aims to transport the hydrocarbon effluents (multiphase mixture of oil, gas, water and solid particles) coming from one or more subsea production wells in order to convey them to a surface installation, for example a floating production, storage and offloading unit (also called FPSO).

These networks generally comprise several subsea pipelines which are laid on the seabed and in which the multiphase effluents coming from the production wells circulate.

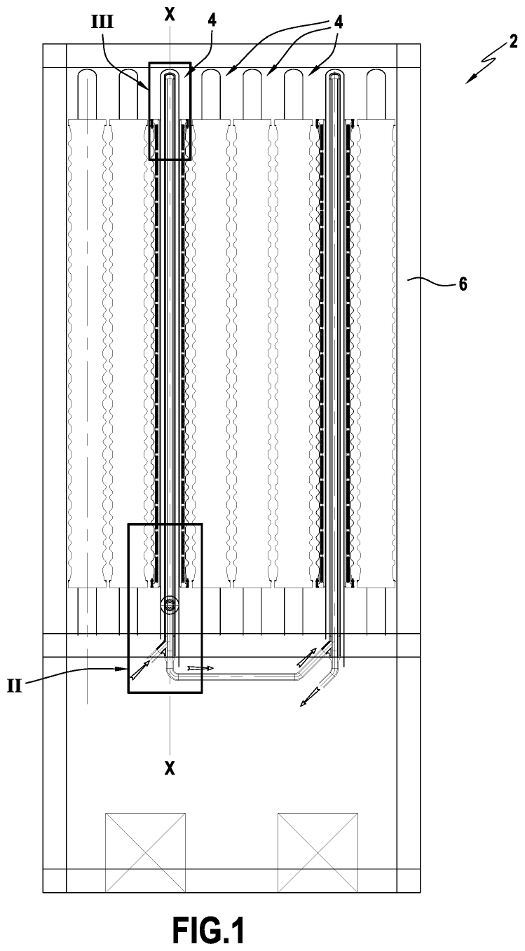

To maintain the effluents transported in these subsea pipelines at a temperature above a critical threshold making it possible to avoid the formation of deposits inside said pipelines, the invention provides for connecting the pipelines to one or more removable subsea heating installations such as the one represented in FIG. 1.

The heating installation 2 represented in this figure is removably connected to a subsea pipeline (not represented). It is controlled from the surface installation (not represented in the figure) depending in particular on the operating mode of the network (typically: normal operating phase, preservation phase or production restart phase).

In general, the heating installation 2 according to the invention comprises a plurality of pipeline sections 4 which are connected to each other and which are disposed in a substantially vertical direction. The pipeline sections 4 are arranged inside a parallelepiped-shaped frame 6.

Each pipeline section 4 is disposed vertically, that is to say it extends along a mainly vertical direction, that is to say parallel to the direction of gravity.

Furthermore, each pipeline section 4 comprises an inner tube 8 centered on a vertical axis X-X and an outer tube 10 disposed around the inner tube while being coaxial therewith.

At its lower vertical end, the outer tube 10 comprises an intake aperture 12 which allows vertical circulation of the multiphase effluent from bottom to top in the annular space 14 which is delimited between the outer tube and the inner tube.

At its upper vertical end, the inner tube 8 opens inside an upper vertical end of the outer tube 10. Finally, at its lower vertical end, the inner tube 8 emerges towards a discharge outlet 16 for the multiphase effluent.

Thus, the multiphase effluent coming from the subsea pipeline penetrates inside the pipeline section 4 of the heating installation according to the invention from the bottom by entering the annular space 14 delimited between the outer tube and the inner tube through the intake aperture 12. The effluent flows vertically in this annular space 14 from bottom to top then, at the upper end of the pipeline section, reverses to be directed towards the inner tube 8 inside which it flows vertically from top to bottom. The effluent is then discharged from the bottom of the pipeline section via the discharge outlet 16.

It will be noted that the passage section of the annular space 14 delimited between the outer tube and the inner tube can be equal to the passage section of the inner tube 8 so that the flow speeds of the effluent are identical in the upward direction and downward direction. Ideally, the passage section of the annular space 14 is minimized in order to obtain the highest possible flow velocity, which promotes heat transfer. Similarly, it is preferable to have an inner tube with a small passage section so as to reduce the diameter of the outer tube, and therefore the overall weight of the pipeline section.

It will also be noted that the pressure difference between the interior of the inner tube 8 and the interior of the annular space 14 delimited between the outer tube and the inner tube is very low, so that it is possible and advantageous to give a very small thickness (of the order of a few millimeters) to the inner tube. For example, the latter can be made of a corrosion-resistant alloy.

Each pipeline section 4 of the heating installation according to the invention further comprises a thermal insulation layer 18 which is disposed around the outer tube 10, as well as a system 20 for heating by induction the outer tube which is disposed around the thermal insulation layer 18.

The induction heating system 20 consists of one or more induction coils 22 which are wound in superimposed rows around the thermal insulation layer 18. These induction coils 22 are supplied with alternating electric current so as to generate an induced current in the outer tube 10 to heat it.

The induction heating system also comprises a flexible shell 24 which is disposed around the induction coils 22 in order to form a hermetic enclosure, the latter being filled with a liquid which is at equal pressure with the external environment (namely the surrounding sea water).

The induction coils 22 of the heating system extend over the entire height of the pipeline section, except for an upper end portion P which is not surrounded by the induction coils, and therefore which is not subjected to the induction heating.

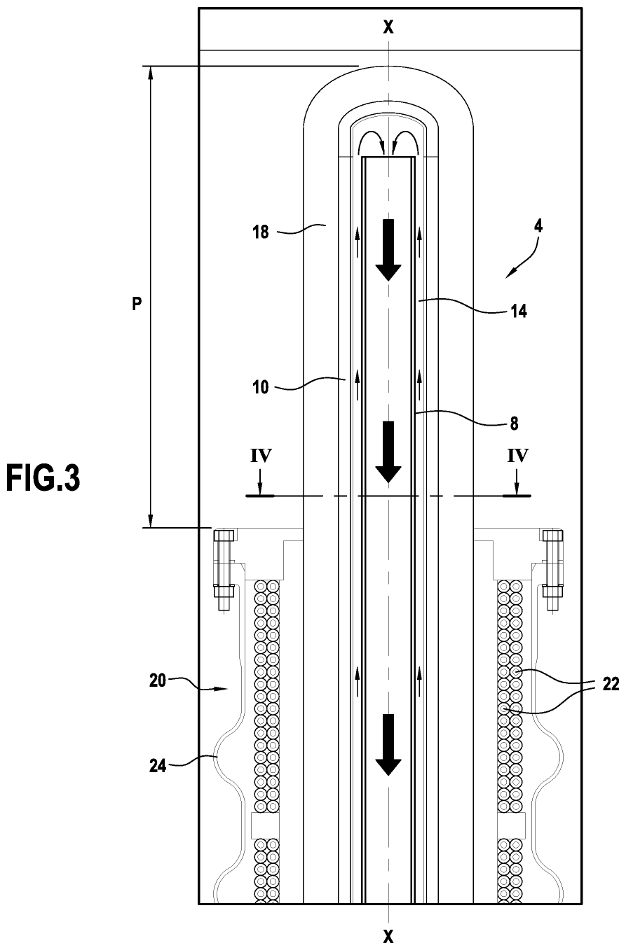

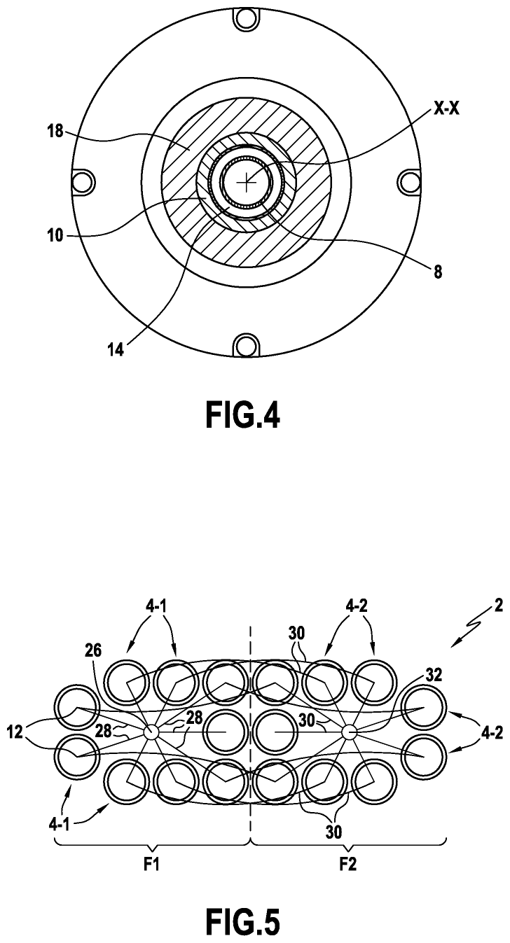

This unheated upper end segment P which is visible in particular in FIG. 3 encompasses in particular the upper end area of the outer tube 10 in which the inner tube 8 opens (area in which the multiphase effluent reverses to be directed inside the inner tube).

This upper end area of the outer tube 10 is the location in which a gas pocket of the multiphase effluent circulating in the pipeline section is likely to stagnate. As this area is not subjected to the induction heating, there is therefore no risk of heating stagnant gas in this high portion which could lead to destructive overheating of the thermal insulation layer 18.

According to one advantageous disposition visible in particular in FIG. 3, the end segment of the outer tube 10 of the pipeline section has at its upper end a shape l0a which is curved outwards. This curved shape l0a makes it possible to increase the resistance to the internal/external pressure differential and to limit the pressure drops of the flow of the multiphase effluent during its passage from the annular space 14 towards the inside of the inner tube 8.

According to another advantageous disposition not represented in the figures, the end segment of the outer tube 10 of the pipeline section can contain a conical part which is curved inwards so as to improve the guiding of the effluent from the annular space 14 towards the inside of the inner tube 8.

According to yet another advantageous disposition not represented in the figures, the pipeline section also comprises a plurality of centralizers which are positioned in the annular space 14 between the outer tube and the inner tube. These centralizers ensure centering and maintenance of the inner tube inside the outer tube.

For example, the centralizers can take the form of rings which are perforated to disturb as little as possible the flow of the multiphase effluent in the annular space between the outer tube and the inner tube.

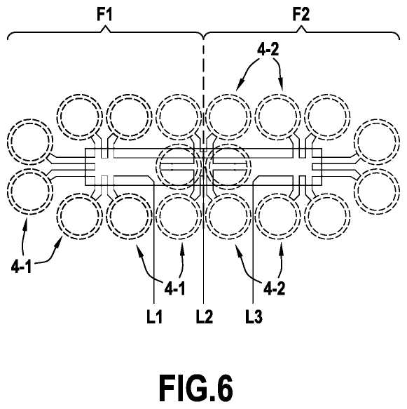

In relation to FIGS. 5 and 6, an example of arrangement of the pipeline sections of the heating installation according to the invention will now be described.

In this exemplary embodiment, the pipeline sections 4 of the heating installation are arranged in two distinct bundles F1, F2 each of nine pipeline sections.

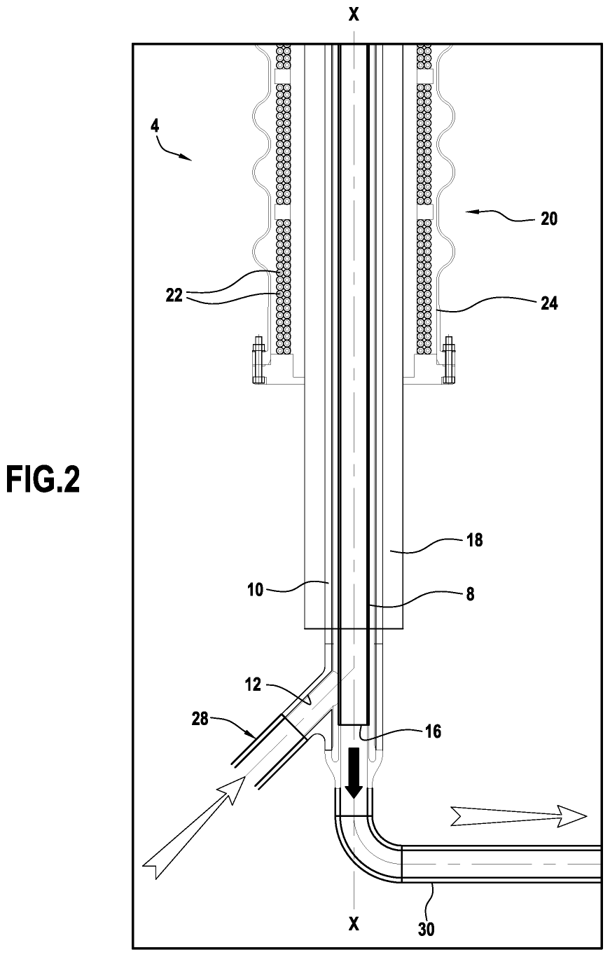

Each bundle F1, F2 thus comprises nine pipeline sections, respectively 4-1 and 4-2, the pipeline sections 4-1 of one of the bundles (here the bundle Fl) being supplied with multiphase effluent via a common distributor 26. This distributor 26 is positioned at the center of the pipeline sections 4-1 and is connected by fittings 28 (see FIG. 2) to the intake aperture 12 of the outer tube of each pipeline section.

Furthermore, each of the pipeline sections 4-1 of the bundle Fl supplies multiphase effluent to the pipeline sections 4-2 of the other bundle F2. This supply of the pipeline sections of the second bundle can occur in series or in cascade (that is to say in parallel).

In the exemplary embodiment of FIGS. 2 and 5, this supply is in series and carried out by means of fittings 30 connecting the discharge outlet 16 of the inner tube of each pipeline section 4-1 of the bundle Fl to the intake aperture 12 of the outer tube of each pipeline section 4-2 of the other bundle F2.

In addition, the discharge outlets 16 of the inner tube of each pipeline section 4-2 of the bundle F2 emerge towards a common outlet manifold 32.

FIG. 6 represents the electrical supply diagram of the heating installation according to the arrangement described in relation to FIG. 5.

More specifically, this FIG. 6 shows the different electrical connections of the induction coils of the system for heating each pipeline section 4-1, 4-2 of the two bundles F1, F2 to the three phases of a three-phase electrical power network.

The power supply occurs via a three-phase electric current, each phase L1, L2 and L3 of which is connected to a group of six pipeline sections 4-1, 4-2. More specifically, the phase L1 is connected to a group of six pipeline sections 4-1 of the bundle F1, the phase L2 is connected to a group of six pipeline sections comprising three pipeline sections 4-1 of the bundle F1 and three pipeline sections 4-2 of the bundle F2, and L3 is connected to a group of six pipeline sections 4-2 of the bundle F2.

Other arrangements than those described in relation to FIGS. 5 and 6 can be of course envisaged.

For example, the pipeline sections of the two bundles can be arranged in an interlocked disposition, rather than a disposition in two distinct groups.

Similarly, the heating installation can alternatively comprise three bundles of pipeline sections each comprising six pipeline sections.

1-15. (canceled).

16. A subsea installation for heating a multiphase effluent circulating inside a subsea shell, comprising at least one pipeline section disposed along a substantially vertical direction, the pipeline section comprising an inner tube, an outer tube disposed around the inner tube while being coaxial therewith, a thermal insulation layer disposed around the outer tube, and a system for heating by induction the outer tube disposed around the thermal insulation layer, the outer tube comprising at a lower end an intake aperture in order to allow circulation of the multiphase effluent from bottom to top in an annular space delimited between the outer tube and the inner tube, and the inner tube opening at an upper end inside the outer tube and emerging at a lower end towards a discharge outlet for the multiphase effluent in order to allow counter-current circulation of the multiphase effluent from top to bottom inside the inner tube.

17. The installation according to claim 16, wherein the inner tube of the pipeline section opens at an upper end inside the outer tube at an end segment thereof which is devoid of induction heating.

18. The installation according to claim 17, wherein the end segment of the outer tube of the pipeline section has at its upper end a curved shape outwards so as to limit the pressure drops of the flow of the multiphase effluent during its passage from the annular space towards the inner tube.

19. The installation according to claim 17, wherein the end segment of the outer tube of the pipeline section contains a conical part which is curved inwards so as to improve the guiding of the effluent from the annular space towards the inner tube.

20. The installation according to claim 16, wherein the passage section of the annular space is substantially equal to the passage section of the inner tube.

21. The installation according to claim 16, wherein the pipeline section comprises a plurality of centralizers which are positioned in the annular space between the outer tube and the inner tube.

22. The installation according to claim 16, wherein the system for heating by induction the pipeline section comprises at least one induction coil wound around the thermal insulation layer and supplied with alternating electric current so as to generate an induced current in the outer tube to heat it.

23. The installation according to claim 22, wherein the pipeline section further comprises a flexible shell disposed around the induction coil of the heating system in order to form a hermetic enclosure, said enclosure being filled with a liquid at equal pressure with the external environment.

24. The installation according to claim 16, wherein the inner tube of the pipeline section is made of a corrosion-resistant alloy.

25. The installation according to claim 16, comprising a plurality of pipeline sections) which are supplied with multiphase effluent via a common distributor into which the intake aperture of the outer tube of each pipeline section emerges.

26. The installation according to claim 25, comprising at least two bundles of pipeline sections, each bundle comprising a plurality of pipeline sections, the pipeline sections of the one of the bundles being supplied with multiphase effluent via a common distributor and supplying in series or in cascade multiphase effluent to the pipeline sections of another bundle whose discharge outlets emerge towards a common manifold.

27. The installation according to claim 26, comprising two bundles of pipeline sections each comprising nine pipeline sections.

28. The installation according to claim 26, comprising three bundles of pipeline sections each comprising six pipeline sections.

29. The installation according to claim 27, wherein the pipeline sections of all the bundles are arranged inside the same parallelepiped volume in several distinct groups of pipeline sections corresponding to the different bundles or in an interlocked disposition of the pipeline sections of the different bundles.

30. A method for the subsea heating of a multiphase effluent circulating inside a subsea shell, comprising the circulation, along a vertical direction from bottom to top, of the multiphase effluent inside of an annular space delimited between coaxial outer and an inner tubes of a vertical pipeline section, followed by counter-current circulation, along a vertical direction from top to bottom, of the multiphase effluent inside the inner tube of the pipeline section, with the application of an induction heating of the outer tube of the pipeline section.
